(19) United States
(12) Patent Application Publication
(10) Pub. No.: US 2025/0381444 A1
(43) Pub. Date: Dec. 18, 2025

(54) SYSTEM AND METHOD FOR ELECTRONICALLY TRACKING AND SCORING MOTION IN DRAWING A FIREARM

(71) Applicant: SHOT MENTOR, LLC, South Jordan, UT (US)

(72) Inventors: Kevin Scott Wyatt, Cottonwood Heights, UT (US); Michael Douglas Larsen, Cottonwood Heights, UT (US)

(73) Assignee: SHOT MENTOR, LLC, South Jordan, UT (US)

(21) Appl. No.: 19/224,619

(22) Filed: May 30, 2025

Related U.S. Application Data
(60) Provisional application No. 63/659,279, filed on Jun. 12, 2024.

(51) Int. Cl. A63B 24/00; A63B 71/06

(52) U.S. Cl. CPC A63B 24/0006; A63B 71/0605; A63B 2024/0012; A63B 2220/806

(57) ABSTRACT

A computer system facilitates analysis and scoring of user motion in drawing and presenting a firearm for discharge. The system receives video image of a user drawing, presenting, and discharging a firearm, generates a user skeletal wireframe model in real time and displays the user skeletal wireframe model overlaid on video image of the user in real time. The system identifies the firearm discharge by detecting sound associated with the firearm discharge or firearm position. The system analyzes the movement of the user in drawing, presenting and discharging the firearm and generates a movement score corresponding to the accuracy of user motion in drawing, presenting and discharging the firearm. The system analyzes the user elapsed time drawing, presenting, and discharging the firearm and generates a time score for the user. The system generates a shot score based on the movement score and the time score.

### PRIORITY

The present application claims the benefit of U.S. Provisional Application Ser. No. 63/659,279, filed Jun. 12, 2024, which is herein incorporated by reference in its entirety.

### THE FIELD OF THE INVENTION

The present invention relates to firearms training. In particular, examples of the present invention relate to a computer implemented system for tracking and scoring body motion of a person while drawing a firearm.

### INTRODUCTION

Persons such as law enforcement officers or competition shooters often desire to improve the action of drawing and presenting a firearm. These individuals are in situations where it is important to draw and present a firearm quickly, accurately, and consistently.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic which shows a computer system used to provide electronic analysis of user motion in drawing, presenting, and discharging a firearm according to a firearm draw motion tracking and scoring system.

FIG. 2 is a flowchart diagram of a method of electronic analysis of user motion in drawing, presenting, and discharging a firearm.

FIG. 3 is a drawing of a user computer interface used to facilitate electronic analysis of user motion in drawing, presenting, and discharging a firearm.

FIG. 4A is a drawing of a user computer interface used to facilitate electronic analysis of user motion in drawing, presenting, and discharging a firearm.

FIG. 4B is a drawing of a user computer interface used to facilitate electronic analysis of user motion in drawing, presenting, and discharging a firearm.

FIG. 5 is a drawing of a user computer interface used to facilitate electronic analysis of user motion in drawing, presenting, and discharging a firearm.

FIG. 6 is a drawing of a user computer interface used to facilitate electronic analysis of user motion in drawing, presenting, and discharging a firearm.

FIG. 7 is a drawing of a user computer interface used to facilitate electronic analysis of user motion in drawing, presenting, and discharging a firearm.

FIG. 8 is a drawing of a user computer interface used to facilitate electronic analysis of user motion in drawing, presenting, and discharging a firearm.

FIG. 9 is a schematic drawing which shows a computer used to implement the firearm draw motion tracking and scoring system.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Embodiments may also be implemented in cloud computing environments. In the description and claims, “cloud computing” may be defined as a system for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud system can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). The flowchart or process steps may be performed in alternate order so long as the change in order does not materially alter the result. Each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant digits above or one or two significant digits below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The present system uses a computer system with a camera to track and analyze the motion of a user's body as the user completes the motion of drawing and presenting a firearm. The computer system analyzes the shape and movement of the user captured by the camera and creates a digital wireframe corresponding to the user's skeleton. The computer displays the digitally created wireframe skeleton overlaid on the video of the user as the user draws and presents the firearm. The computer tracks the motion of the wireframe skeleton and compares the motion of the wireframe skeleton to a stored model of skeletal motion for the task being performed. The computer generates a rating for the user's motion based on a comparison with the stored model motion and may rate the user's motion based on speed, accuracy, etc. The computer may create feedback and present feedback to the user. The feedback may include a rating based on speed, accuracy of motion, etc. The computer system may also rank the user according to the speed and accuracy of the user's motion.

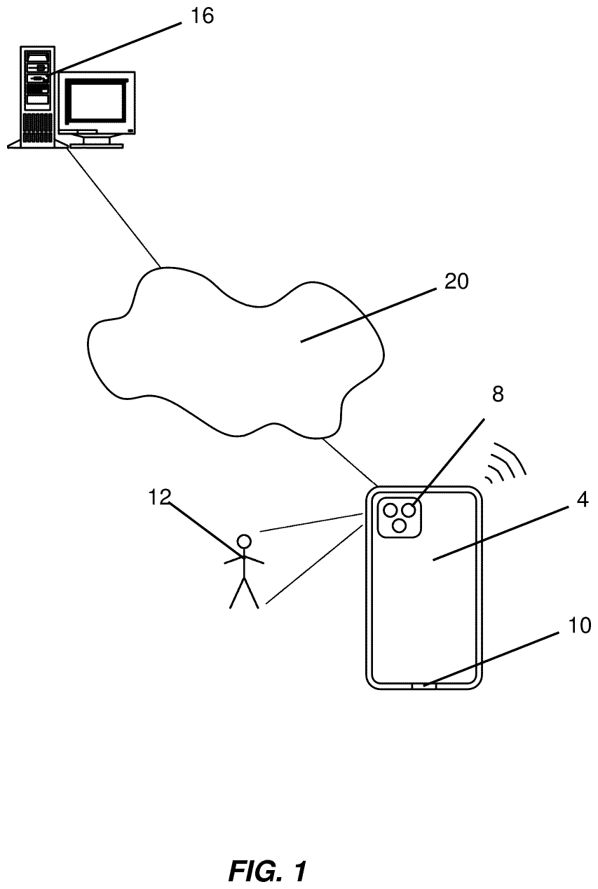

FIG. 1 illustrates an example computer system which may implement the motion tracking and scoring system described herein. In one example, the firearm draw motion tracking and scoring system may be implemented on a computer 4. The computer 4 is operated by a user which uses the computer 4 and camera 8 and microphone 10 to track and analyze the motion of a person 12 (such as the user or another person) while the person 12 draws and presents a firearm. The computer 4 includes hardware and stored software and data necessary to implement the motion tracking and scoring system and to perform the calculations and processes discussed herein. The computer 4 may transmit and receive information from one or more servers 16 which may facilitate analysis of user motion data and which may score the user and rank the user with other users or known persons or which may score the user against other users or known standards or persons to thereby compare the user's motion against a known goal or against other persons. The computer 4 communicates with a server 16 over the internet 20 and via a secure connection. It is appreciated that many of the steps discussed herein may be provided by the computer 4. In other examples, some computational steps such as rating or ranking the user's motion against other users or against a known standard may be performed by the server 16, changing the distribution of computational tasks between the computer 4 and server 16 in operating the motion tracking and scoring system. As used herein, the term draw or drawing refers to the act of drawing a firearm and presenting the firearm to properly discharge the firearm or presenting the firearm to be ready to properly discharge the firearm. Drawing the firearm may include removing the firearm from a holster to present the firearm ready for use.

In describing the present system, reference is made to actions taken by a user or another person such as in operating the computer 4 and in drawing and presenting a firearm. Users interact with the computer 4 and it is understood that when an action or step is described from the user viewpoint a corresponding complementary step is taken by the computer 4. Thus, a user entering or transmitting data is accompanied by the computer 4 receiving the data. In this manner, it is understood that the computer 4 receives data, stores data, calculates and processes data, transmits data, and presents data to facilitate operation of the motion tracking and scoring system and that the user computer 4 and server (computer) 16 are used to perform the steps associated with the firearm shot motion tracking and scoring system.

In describing the present system, the functionality is described with respect to a single example user using a computer 4. It is appreciated that the motion tracking and scoring system is designed to serve multiple distinct and unaffiliated users and to facilitate motion tracking and scoring by multiple unaffiliated user computers 4. The computer(s) 4 may be a mobile phone, laptop, or tablet computer with a camera as part of the device hardware. Alternately, the computer 4 may be a device such as a laptop or desktop computer and may use a separate camera such as a webcam that communicates with the computer.

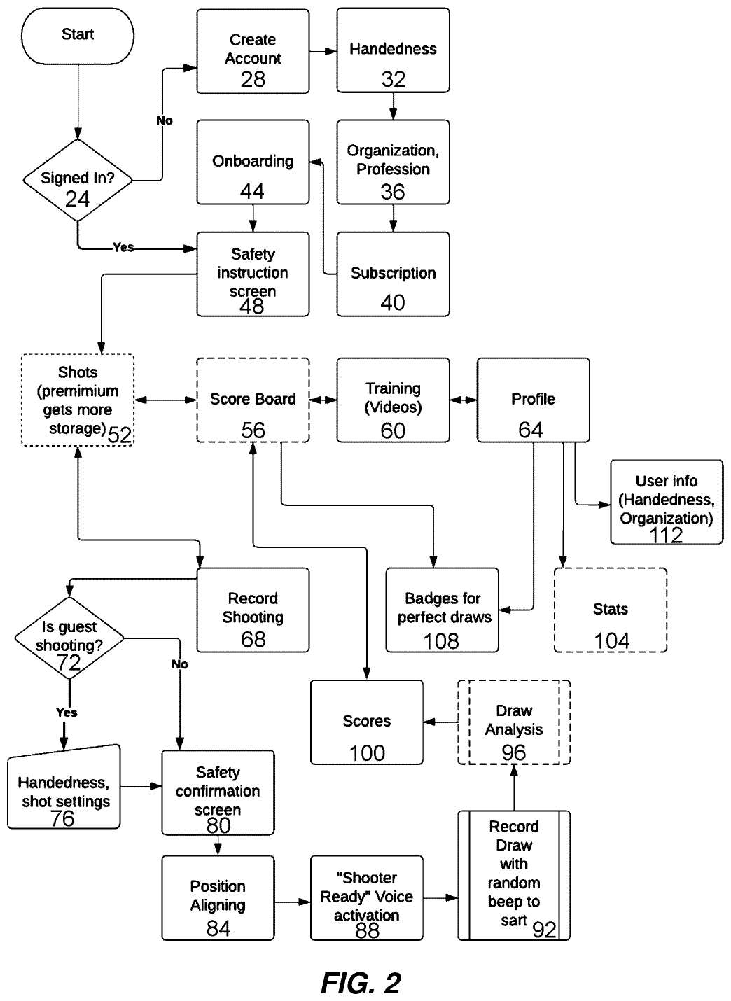

FIG. 2 shows a flowchart for a computer system that is used to facilitate use of the motion tracking and scoring system. A user may use a user computer 4 such as a portable computer or smart phone to sign in 24 to an account on the computer 4 and/or server 16. If the user is new to the system, the user can create an account 28 and will enter required identifying information. User account information may include the person's legal name, age, date of birth, and government issued identification or other verifying document. The user may also enter identifying information related to the use of a firearm, such as by entering whether they are left or right handed 32. Selection of a shooting hand identifies to the computer 4 and firearm draw motion tracking and scoring system software which direction the user should turn or position their body while drawing and shooting and changes how the computer 4 scores the user's shots by determining which hand and arm should be performing which action during a shot. The user may also enter their profession 36 or may enter an affiliation with a group or organization 36. Groups or organizations may include civilians, competitive shooters, law enforcement personnel, military, federal agents, and professionals such as body guards, security agents, investigators, firearms instructors, range masters, etc. Association with a profession or an organization may link the user with other users from that organization or may allow the user to load records, achievements, standards, settings or rules associated with the group or organization. Different organizations may have different shot competitions and rankings for the organization. Different organizations or competitions may have different requirements for training or shots, such as a particular starting posture or shot posture for a certain shot competition within the organization. Association with a particular organization may allow a user to compete against other people withing that organization or compare their scores or progress against different people within that organization.

The user may also choose a subscription setting 40. A paid premium subscription may allow the user access to additional features such as increased storage for recorded firearm draws, draw competition within groups, draw analysis and training, badges or achievements, and draw comparison with other persons such as professionals and record holders. The computer 4 may obtain permissions from the user to use the computer camera 8 and microphone 10. Once sufficient information has been entered into the computer 4, the computer 4 or server 16 will create an account for the user and complete the user onboarding process 44. The computer 4 may, as part of the onboarding process 44, display instruction pages to the user that teach the user how to use the motion tracking and scoring system software. The computer 4 stores account information pertaining to the user and exchanges information on the computer 4 and with the server 16. The motion tracking and scoring system software may obtain permissions from the user to utilize a camera 8 and microphone 10 that are part of or connected to the computer 4. Once an account is created and a user is validated and ready, the user may sign into their account 24 and use the system for firearm draw motion tracking and scoring.

The computer 4 or the firearm draw motion tracking and scoring system may be discussed interchangeably as the computer 4 stores software to implement the firearm draw motion tracking and scoring system and provides the user interface, processing hardware, etc. used to execute the firearm draw motion tracking and scoring system. Example computer screen images discussed herein are user interface images generated by the firearm draw motion tracking and scoring system on the computer 4 and displayed the computer screen. Each of the screens presents information to the user and typically includes user interface elements such as buttons or slider switches that allow a user to use the firearm draw motion tracking and scoring system.

When a user signs into their account 24 on the computer 4, the computer 4 displays a safety instruction screen 48 to the user. The safety instruction screen may include information such as ensuring that the firearm is unloaded and that the user avoid aiming the firearm in any direction that would cause damage if the firearm were loaded and discharged. The computer 4 may display the safety instruction screen to the user each time the user uses the motion tracking and scoring system. The motion tracking and scoring system may provide a user with different features based on a subscription level of a user. A user with a premium account may be provided with additional storage space and resources from the server 16 and additional features within the software on the computer 4 or server 16. A basic user may be able to use the system/computer 4 to record and analyze their movement in drawing and presenting a firearm through a simulated discharge (a “shot”). The system may allow the user to record and view a predetermined number of previous shots, such as their last three shots. A user with a premium account may be able to see all of the shots that they have taken in a predetermined period of time, such as the last 30 days, and may be able to permanently store and view the top shots that they have ever taken, such as the top five shots that they have taken. A user with a premium account may also receive computer generated feedback for improving their shot. For example, the computer 4 may provide feedback on how the user can improve their draw and shot motion such as in suggesting changes to their stance, how they are leaning or standing, their feet spacing, their grip, their draw stroke and motion, their draw timing or speed, and their eye position. The computer may compare the draw stroke/shot motion performed by the user and overlay the motion with an ideal motion in drawing and presenting a firearm for discharge and identify areas where the user motion deviates from ideal motion in timing, coordination of movements, and the position and accuracy of movements including in their stance, how they are leaning or standing, their feet spacing, their grip, their draw stroke and motion, their draw timing or speed, and their eye position and generate feedback instructing the user how to improve their shots. The computer 4 may present the feedback to the user as suggestions on how to change and improve their shot. A user with a premium account may also be able to record and analyze live shots instead of only simulated shots and may chose a shot count such as up to twelve shots to be recorded and analyzed in a single firing session. The computer 4 may also present a dashboard to the user that allows the user to use different features within the motion tracking and scoring system. The computer 4 allows the user to navigate between different screens or sections within the firearm draw motion tracking and scoring software system.

The computer 4 may allow the user to navigate between a shots screen 52, a score board screen 56, a training screen 60, and a profile screen 64. The shots screen 52 allows a user to use the firearm draw motion tracking and scoring system to analyze their motion in drawing a firearm and presenting the firearm for a shot. The shots screen 52 may include a number of user interface elements or may lead through a series of screens to facilitate use of the firearm draw motion tracking and scoring system. The shots screen 56 may include user interface elements that allow a user to select a firearm, select whether they are left or right handed, and select a live or dry fire scenario. The shots screen 52 provides a user interface element that allows a user to select whether or not they will record 68 the shot. A recorded shot is stored for long term storage and retrieval for later review by the user where a non-recorded shot may be stored short term to allow a user to review the shot at that time but not at a later period of time. The shots screen 542 may allow a user to indicate 72 if a guest is shooting. If a guest is shooting, the system allows the user to select settings 76 for the guest such as by selecting a type of firearm, type of shot, left or right handed, etc. The system may present a safety confirmation screen 80 to the user which presents safety information to the user and requires the user to indicate that they are performing the shot safely. The system may include an alignment screen 84 which allows the user or an assistant to properly aim the camera 8 at the user for recording the shot. The alignment screen 84 may display a live video image from the camera 8 that shows the user and allows a person to visually verify that the user is centered within the camera image. The firearm draw motion tracking and scoring system shots screen 52 provides a user interface element that allows a user to indicate that they are ready to take a shot. As discussed, taking a shot includes drawing a firearm from a stored or resting position, moving the firearm to a shooting position, and pulling the trigger for a live shot or a dry (simulated) shot. In one example, the example firearm draw motion tracking and scoring system uses a voice activated firing system. Once the user has set up the software in the desired configuration, the computer 4 displays a screen that shows the user as observed by the camera 8 and displays a green user interface element 88 that directs the shooter to say “shooter ready” to initiate the shot. The computer 4 uses the microphone 10 to listen to the shooter and when the computer detects the phrase “shooter ready” via the microphone 8, the computer 4 initiates the shot sequence. The computer can display the user in real time on the computer screen as the user prepares for and completes the shot.

When the user says “shooter ready,” the computer 4 may wait for a randomly determined period of time between about one second and about ten seconds, and more particularly between about two seconds and about five seconds. After the random period of time, the computer 4 will generate a sound 92 (a beep or buzzer sound) through a computer speaker to indicate to the shooter that they should then begin and complete the shot. The computer will record the shot while the user draws the firearm to a shooting position and depresses the firearm trigger to take a live or simulated shot. The computer 4 will use the computer microphone 10 to listen for and detect a click sound when the trigger is pulled or a firing sound when the firearm is discharged to determine that the shot is completed. The computer 4 will record the shot and store the recorded shot in memory.

In another example, the computer may assist in properly positioning the user for a shot and automatically start the shot once user positioning is confirmed. The computer 4 may display a screen that shows real time video of the user provided by the computer camera and that also shows a box on the screen indicating where, relative to the camera, the user needs to stand. The user may be instructed to stand in a position that optimizes the ability of the computer to accurately record and analyze the user's shot motion. The computer may indicate to the user that the user should stand at the appropriate distance from the camera such that the user's body is positioned within the box and that the user should face the camera with their body turned approximately 30 degrees to the camera. The computer may display the alignment/aiming box in red while the user is not in the correct position for a shot. Once the user is in an appropriate position relative to the camera, the computer may display the aiming box in green to indicate that the user in in a correct position. Once the user is correctly positioned relative to the camera, the computer may request a start indication from the user, or may automatically begin the shot recording process. The computer may then wait for a randomly determined period of time between about one second and about ten seconds, and more particularly between about two seconds and about five seconds. After the random period of time, the computer 4 will generate a sound 92 (a beep or buzzer sound) through a computer speaker to indicate to the shooter that they should then begin and complete the shot. Once the computer has detected that the user is correctly positioned and is beginning the randomized time delay for a shot, the computer may simply present a green screen to the user, indicating to the user that they are correctly positioned and the shot process is beginning. A randomized time delay is important to prevent the user from anticipating when to begin drawing the firearm for the shot. The computer will record the shot while the user draws the firearm to a shooting position and depresses the firearm trigger to take a live or simulated shot. The computer may detect that the process to draw the firearm and present the firearm for discharge has been completed by detecting the position of the firearm. For example, a standard draw for a pistol may have the user draw the firearm, bring the firearm to their chest, grasp the firearm with both hands at their chest, and then extend the firearm forwards towards the target to discharge the firearm. The computer may detect the draw/shot process has been completed when the computer visually detects, via the camera, that the firearm has been thrust forwards from the user's chest and is held in front of the user with the user's arms extended. The computer may also detect that a shot has been completed by detecting the sound of a dry fire or live fire shot via the microphone.

Once the computer 4 has recorded the shot, the computer 4 can analyze the shot and score the shot. Some of the computer analysis of the shot can be performed in real time and some analysis relies on the shot being completed. The computer 4, via the firearm draw motion tracking and scoring system software, can create a wireframe representing the skeleton of the user in real time. The computer 4 analyzes the image of the user generated by the camera and creates key skeletal points that characterize the user's motion in taking a shot with the firearm. These key points are connected by lines, generating a rough skeletal model of the user. The user skeletal model includes points or nodes that represent joints of the user's skeleton and lines connecting the nodes. The skeletal model creates a basic representation of the user's skeleton and is used to evaluate the user's motion in drawing the firearm. The user skeletal model may be created by the computer 4 and overlaid over and added to the video image of the user so that the user skeletal model and can be seen in the recorded video of the user's shot and can also be seen in real time in the alignment screen 84 and shot screen as the user prepares for and completes the shot.

In creating the skeletal model, the computer 4 does not model each of the user's bones or joints. Rather, the computer models key points that are relevant to analyzing and scoring the user's shot. The computer 4 models skeletal joints as points or nodes in the skeletal model and models bones as straight lines connecting the nodes. The computer may identify some joints/nodes by identifying the center axis of the user's limb such as the user's arms, legs, and fingers. The computer may visually identify the center of the limb based on the video image of the limb and create a skeletal wireframe line along the visual center of the limb along the central axis of the limb. The computer may identify nodes in the user's hand and torso via the limb endpoints; such as by identifying where a first limb central axis intersects a torso or intersects a second limb central axis. In this way, the computer may identify where an upper arm central axis intersects a forearm central axis and place a node at that point with lines along the central axes to represent arm bones in the skeletal wireframe model. The skeletal model of the user typically includes nodes at the user's feet, knees, hips, shoulders, elbows, wrists, finger joints, and finger tips and may include a node for the user's neck or head. The user's torso is typically modeled by connecting the hip and shoulder nodes with lines to create a quadrilateral. The computer 4 includes the user's eyes as part of the skeletal model as eye movement or direction may be used to score the shot. The computer may create/draw a rectangle around the user's eyes to indicate the eyes in the skeletal model. The computer may create/draw a circle or oval around the user's head to represent their head in the skeletal model. The computer 4 can create the user skeletal model in real time and overlay the skeletal model over the images captured by the camera 8 and display the skeletal model as part of the live preview image or recorded video. The computer records the skeletal model as part of the recorded video of the user's shot.

The user takes a shot after the computer produces the starting beep 92. In taking a shot with a pistol that is holstered, the user may start in a standing position. In one example, the user may start in a formal position with their feet shoulder width apart and their arms down at their side and with their head facing forward. Once the computer produces the start beep 92, the user should bring their gun hand straight up and then straight down onto the gun. At the same time, their other, non-shooting hand should move up to their chest. The user should move their gun hand to grab the pistol and pull the pistol up from the holster and move the pistol to a position in front of their chest. They should then grab the pistol with their non-shooting hand close to their chest. With the pistol in a two handed grip, the user should than move the pistol straight out from their chest towards the target with the pistol aimed at the target and their eyes centered on the target without adjusting the aim of the pistol after moving the pistol forwards towards the target. The computer may identify a deviation between the firearm point of aim and the direction that the user's eyes are oriented to determine how accurately the user is looking at the intended target and aiming at the target. Once the pistol is in a shooting position and aimed at the target, the user should move their trigger finger to the trigger and then pull the trigger without anticipating recoil or moving the firearm before, during, or after the trigger pull. This example may represent an idealized motion in performing a certain type of shot with a firearm.

The computer 4 will analyze 96 and score 100 the shot based on time and based on movement accuracy. In one embodiment, the computer 4 analyzes the user's movement and assigns a movement score M to the movement in taking a shot based on accuracy of the movement. The movement score may be based on a perfect score of 100 where the computer 4 may assign a movement score of 100 to a perfect shot movement and may lower the score based on deviation from ideal movement. The computer 4 may analyze the movement of the recorded skeletal wireframe model of the user to analyze the movement and compare the user movement with idealized movement in completing the shot. The computer 4 may analyze the movement of the skeletal model to determine if the user moved their hands in a straight line, or a curved path. The computer 4 may analyze the skeletal model movement to determine if the user grasped the firearm with their second hand close to and in front of their chest or at a position farther away from their chest. The computer may analyze the skeletal model movement to determine if the user moved the firearm forwards directly towards the target or if the user corrected their aim after bringing the firearm forwards. The computer may analyze the skeletal model movement to determine if the user had their eyes on the target at all times. The computer 4 may analyze the skeletal model movement to determine if the user moved the firearm during the trigger pull. The computer may analyze the user's stance, how they are leaning or standing, their feet spacing, their grip, their draw stroke and motion, their draw timing or speed, and their eye position and may compare the user motion in drawing and presenting a firearm for discharge with an ideal motion in drawing and presenting the firearm for discharge and analyze for differences between user motion and ideal motion. The computer may overlay the video image of the user draw motion with a stored video image of an ideal draw motion and identify discrepancies or deviations of the user draw motion. The computer may compare the timing and coordination of the user draw motion with the ideal draw motion. For an example handgun draw, the user should begin with hands down at their side. Once instructed to begin the draw, the user should move their gun hand to the firearm and should begin moving their other hand to their chest. Once the user draws the firearm, their gun hand should meet their other at the center of their chest to grasp the firearm in a two handed grip. The user should them move the firearm forwards from their chest towards the target with their eyes on the target. The computer may analyze the different parts of the firearm draw motion to identify deviations in timing, movement coordination, movement accuracy based on angular movement or position as compared to an ideal motion. The computer may determine the extent of a user's deviation from an ideal motion in drawing, presenting, and discharging a firearm any may lower the user's movement score proportionately to a deviation distance between a user's motion path and an ideal motion path. The movement score may be reduced based on angular deviation between the user's motion path and an ideal motion path or based on distance deviation between the user's motion path and an ideal motion path. The deviation may include deviation in particular end points of motion or way points of motion such as points where a user should change direction of motion or perform certain steps in the shot such as grasping, presenting, aiming, and discharging the firearm. Thus, a user may achieve a high motion score such as 94 for a very good motion in drawing, presenting, and discharging a firearm or a low motion score such as 25 for poor motion in drawing, presenting, and discharging a firearm where the user's motion deviates significantly from ideal motion.

The computer 4 also assigns a time score T to the user's motion in drawing, presenting, and discharging a firearm based on the time between the start beep 92 and the detected firearm discharge (shot or click from trigger pull). An ideal score may be based on a time of one second in drawing and discharging the firearm. The time score may be based on an ideal score of 1 where the computer 4 assigns a time score of 1 to a shot that occurs within one second and a lower score to a shot that takes longer than one second. In the present example, the computer may lower the time score to 0.1 when the time to discharge the firearm reaches a value of about 4 seconds, and may lower the time score to 0.01 when the time to discharge the firearm reaches a value of about 10 seconds. Thus, the time score T for a shot completed in t seconds may be: T=1 for a time t between 0 and 1 seconds, T=1-0.3* (t−1) for a time t between 1 and 4 seconds, and T=0.1-0.015* (t−4) for a time t between 4 and 10 seconds, and T=0.01 for a time t greater than 10 seconds.

The final shot score S assigned by the computer 4 to the user's shot is the movement score M multiplied by the time score T such that S=M*T. An example user shot with good movement that occurred in time t of 1.2 seconds achieved a movement score M of 87 and a time score T of 0.94 for a shot score S of 81.78. An example user shot with very good movement that occurred in time t of 1.4 seconds achieved a movement score M of 96 and a time score T of 0.88 for a shot score S of 84.48. An example user shot with poor movement that occurred in time t of 0.9 seconds achieved a movement score M of 53 and a time score T of 1 for a shot score S of 53.

In one example, the computer 4 may record, analyze, and score individual shots. In another example, the computer may record, analyze, and score groups of shots, such as five shots, to generate an average shot rating for the user at that time. Scoring a single shot or a group of shots may be selected based on whether the user is learning and tracking progress or participating in a competition, for example. Certain competitions mya require all shots to be scored and recorded. For a user that is learning or practicing, the firearm draw motion tracking and scoring system may have the user perform five shots and may give an average score for the five shots. The firearm draw motion tracking and scoring system may provide feedback to the user based on the shots. The firearm draw motion tracking and scoring system, in analyzing how the user's motion in drawing, presenting, and discharging a firearm differs from an ideal motion, can provide feedback to the user about precisely how they can change their motion to improve their shots. The computer 4/firearm draw motion tracking and scoring system can provide feedback to the user to indicate to the user which parts of the shot motion are performed correctly and which parts of the shot motion are performed incorrectly. The computer 4/firearm draw motion tracking and scoring system can also provide feedback and instruction to the user about how they can better prepare for a shot. The system can provide instruction to the user about how to position their body before the shot and train the user generally on the positioning and motions of their body throughout the shot process.

The computer 4 may present the user's scores 100 (shot scores S) to the user via one or more score screens 56. Additionally, the score screen 56 may present the user's scores 100 for their last x number shots and may present the user's top scores. Depending on the user's account level (e.g. basic account or premium account) the computer 4/firearm draw motion tracking and scoring system may track and provide a history of a predetermined number of shots and may chart the progress of the user in learning and perfecting the motion of drawing a firearm and discharging the firearm.

The computer may track the motion of drawing, presenting, and discharging a firearm for different types of shooting and different types of firearms. For example, certain types of shooting competitions may require the user to start in a particular starting posture of even a casual standing posture. Other types of firearms such as a rifle or shotgun may require a different starting and shooting posture and a different draw motion. A shotgun may require the user to start with the gun held with the barrel down and the shotgun butt off of the body and the draw motion may require the user to place the shotgun butt against their shoulder and raise the shotgun barrel up to point at the target. These different types of shots may be similarly analyzed and scored by analyzing and assigning a motion score M and a time score T for a resulting shot score S as discussed above.

The firearm draw motion tracking and scoring system may provide a score screen 56 which allows a user to select different options in viewing scores 100 and to navigate to additional pages to display their scores, score history, tracked scores over time, and scores within different groups of competitions. The score screen 56 may also allow the user to access badges or awards for perfect shots, competition rankings, organization rankings, etc.

The firearm draw motion tracking and scoring system may provide the user with information about how many perfect shots they have performed, or how many shots in a row the user has performed that are above a score threshold. The firearm draw motion tracking and scoring system may also present a scoreboard to the user that shows the best shot scores, perfect shots, best shot times, etc. for the user and may also provide a count of how many shots the user has taken in total or during a particular time period to help the user gauge their progress and effort. The firearm draw motion tracking and scoring system may also present a scoreboard that displays to the user shot score information for other individuals in the user's organizations and competitions and may allow the user to filter the scoreboard based on organization, location, gender, etc.

The firearm draw motion tracking and scoring system may use time periods for competitions or automatically create time periods such as each month that rank users within a particular organization for the associated time period and competition. The system may provide a countdown or indication to the user about how much time remains in a given time period and provide information to the user about how they rank for that competition or time period. User's may receive badges or awards for being in the top three shooters for a given time period or competition and individual competition or time period badges may contribute to an overall user ranking or badge that is visible on the user's profile screen 64 or system home screen.

The firearm draw motion tracking and scoring system may also provide a training screen 60 which presents training information and videos to users. The training screen 60 may present training information and videos on how to use the firearm draw motion tracking and scoring system. The training screen 60 may also present information and videos on technique such as on drawing, presenting, and discharging a firearm including on a user's stance, motion, aiming, and speed in using the firearm and in using different types of firearms such as hand guns, rifles, and shotguns. The training screen 60 may also present safety information and videos including safe use of firearms, clearing ammunition jams or gun malfunctions, cleaning and maintaining guns, and storing guns. The training screen 60 may also present information and videos and reviews on ammunition, targets, and firearms. Users may search for and view particular videos or types of videos or may view videos by category.

The firearm draw motion tracking and scoring system may provide a profile screen 64. A profile screen 64 may allow the user to access and view statistics 104, badges and awards 108 that are awarded to the user for perfect shots, competition rankings, organization rankings, etc. The profile screen 64 may also allow the user to access and modify user settings 112 such as affiliation with different groups or organizations, affiliation with different competitions or groups or different shooting styles, left or right handedness, etc. The profile screen 64 may allow the user to update account information or subscription information.

The profile screen 64 or shot screen may also allow the user to select different firearms, such as pistols or handguns, rifles, and shotguns for shooting and may allow the user to select different shooting styles such as trap shooting, target shooting, cowboy shooting or formal shooting to allow the user to perform different types of shots and firearms and to configures the firearm draw motion tracking and scoring system to analyze and score these different types of shots and firearms. The profile screen 64 or the shot screen 52 may allow the user to select different starting stance options such as hands by side, fighting stance, or gun transition to change what ideal motion is used to analyze and score the users shot.

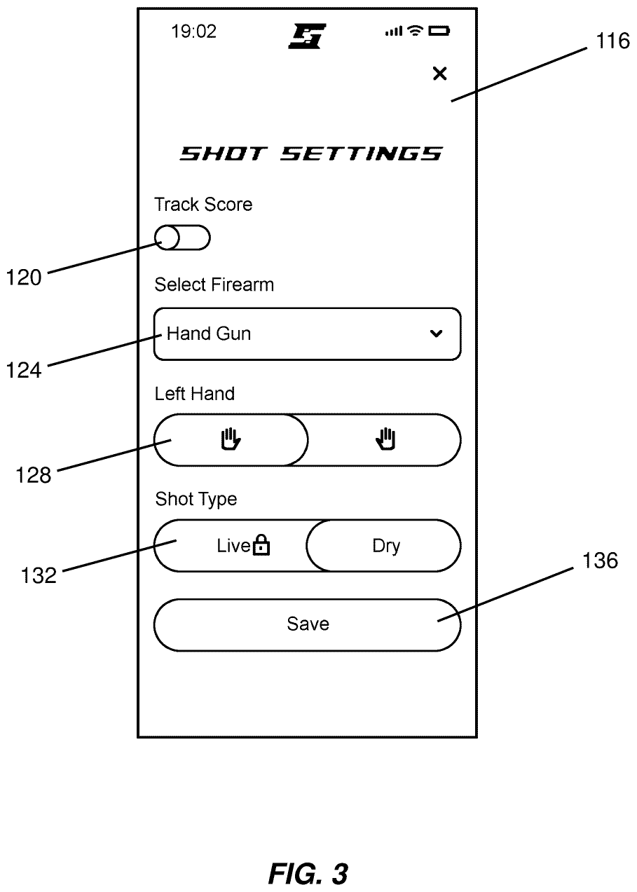

FIGS. 3 through 8 show display screens presented to a user by the computer 4. The screens provide a user interface and allow the computer 4 to present information to a user and to receive information from the user while the user uses the firearm draw motion tracking and scoring system.

FIG. 3 shows a drawing of a shot settings screen 116 displayed on a user mobile phone computer 4. The shot settings screen 116 may be displayed in association with the shots screen 52, account creation screen 28, 32, or profile screens 64, 112 and includes data entry fields to allow the user to select to track their shot scores 120, select a type of firearm 124, select their left or right hand 128 for shooting, and to select a live or dry fire shot type 132. A button 136 to save the settings is provided.

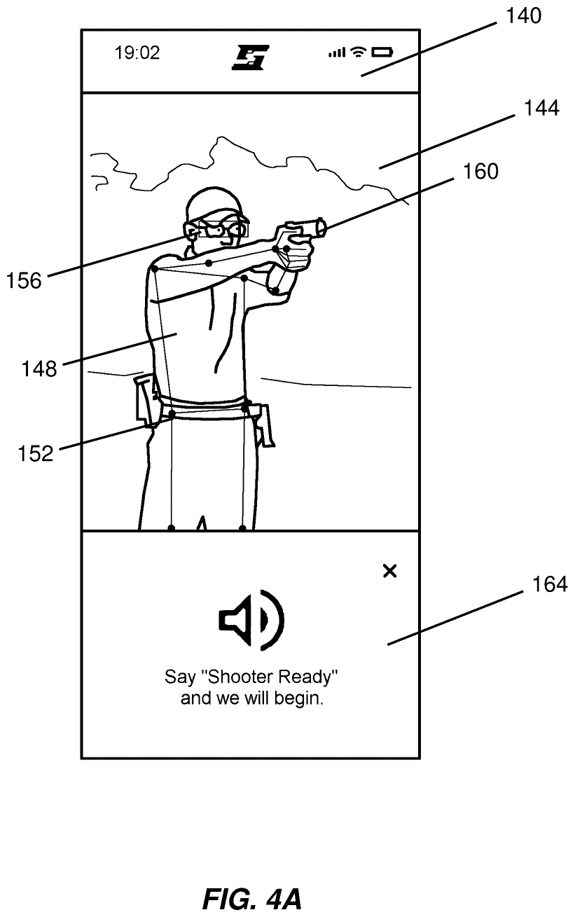

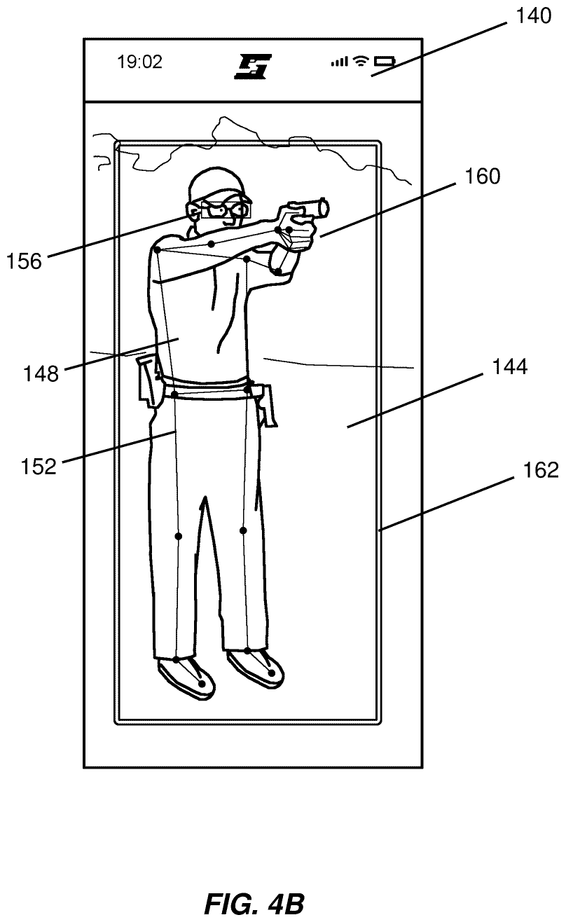

FIG. 4A shows a drawing of an example shot screen 140 displayed on a user cell phone computer 4 and presented to the user as the user is using the firearm draw motion tracking and scoring system via the cell phone computer 4. The shot screen 140 includes a live view window 144 that displays a current image of the shooter 148 as captured by the computer camera 8. The live view window 144 shows a user skeletal model 152 that includes straight lines joined at nodes that represent the user's skeleton. The user skeletal model 152 is overlaid on top of the video image of the user 148 and is created, updated, and displayed in real time as the user moves. As described above, the computer 4 creates the user skeletal model 152 by visually identifying predetermined key skeletal anchor points representing joints at feet, knees, hips, shoulders, elbows, wrists, fingers, and eyes on the captured image of the shooter 148, displaying the skeletal anchor points as node point dots on the image of the shooter 148 and connecting these node points with straight lines that are also displayed on the image of the shooter 148 in real time. The system creates the skeletal model in real time and displays the user and overlaid skeletal model in real time video on the computer display screen as the user moves and completes a shot. The system also records and stores the video of the user with the overlaid skeletal model. The skeletal model also includes an eye box 156 that identifies the user's eyes as the computer 4 tracks the proper orientation of the user's head and eyes to take a shot with the firearm 160. The eye box 156 is a geometric outline that surrounds the user's eyes and is used by the computer to evaluate the position of the user's eyes while completing a shot. A screen similar to the shot screen 140 may be presented as a position aligning screen 84. In this situation, the live view window may occupy more of the computer screen. When the shot screen 140 is used to take a shot 88, 92, the display screen may include a start shot window 164 that allows the user to start the process of taking a shot with the firearm 160. In the example, the start shot window 164 instructs the shooter to say “shooter ready” to begin the shot process. Once the user begins the shot process, the computer 4 will wait for a brief, random period of time before generating a start tone with a speaker after detecting the spoken phrase “shooter ready” with the computer microphone.

FIG. 4B shows a drawing of another example shot screen 140 displayed on a user cell phone computer 4 and presented to the user as the user is using the firearm draw motion tracking and scoring system via the cell phone computer 4. The shot screen 140 includes a live view window 144 that displays a current image of the shooter 148 as captured by the computer camera 8. The live view window 144 may show a user skeletal model 152 that includes straight lines joined at nodes that represent the user's skeleton. The user skeletal model 152 may be overlaid on top of the video image of the user 148 and may be created, updated, and displayed in real time as the user moves. As described above, the computer 4 creates the user skeletal model 152 by visually identifying predetermined key skeletal anchor points representing joints at feet, knees, hips, shoulders, elbows, wrists, fingers, and eyes on the captured image of the shooter 148, displaying the skeletal anchor points as node point dots on the image of the shooter 148 and connecting these node points with straight lines that are also displayed on the image of the shooter 148 in real time. The skeletal model 152 may similarly be created by analyzing user limbs to create lines along the center of the user limbs and by placing node points at the intersection of user limb lines. The system may create the skeletal model in real time and displays the user and overlaid skeletal model in real time video on the computer display screen as the user moves and completes a shot. The system also records and stores the video of the user with the overlaid skeletal model. The skeletal model also includes an eye box 156 that identifies the user's eyes as the computer 4 tracks the proper orientation of the user's head and eyes to take a shot with the firearm 160. The eye box 156 is a geometric outline that surrounds the user's eyes and is used by the computer to evaluate the position of the user's eyes while completing a shot. The shot screen 140 may also include an alignment box 162 that is presented on the screen and that indicates where, relative to the camera, the user needs to stand. The user may be instructed to stand in a position that optimizes the ability of the computer to accurately record and analyze the user's shot motion. The computer may indicate to the user that the user should stand at the appropriate distance from the camera such that the user's body is positioned within the alignment box 162 to largely fill the alignment box 162 and that the user should face the camera with their body turned approximately 30 degrees to the camera. The computer may display the alignment/aiming box 162 in red while the user is not in the correct position for a shot. Once the user is in an appropriate position relative to the camera, the computer may display the alignment box 162 in green to indicate that the user in in a correct position. Once the user is correctly positioned relative to the camera, the computer may automatically begin the shot recording process. The computer may display a green screen to the user to indicate that the computer has begun the shot recording process. The computer may wait for a randomly determined period of time between about one second and about ten seconds, and more particularly between about two seconds and about five seconds before indicating to the user that the user should begin to draw and present the firearm for discharge. Once the random period of time has elapsed, the computer may generate a start tone with a speaker to indicate to the user that the user should begin the draw/shot process. The computer may record the user motion in drawing and presenting the firearm for discharge and may determine that the user has completed the motion by confirming that the firearm has been placed in the proper position for discharge via the camera, or by detecting the sound of a dry fire or discharge via the microphone.

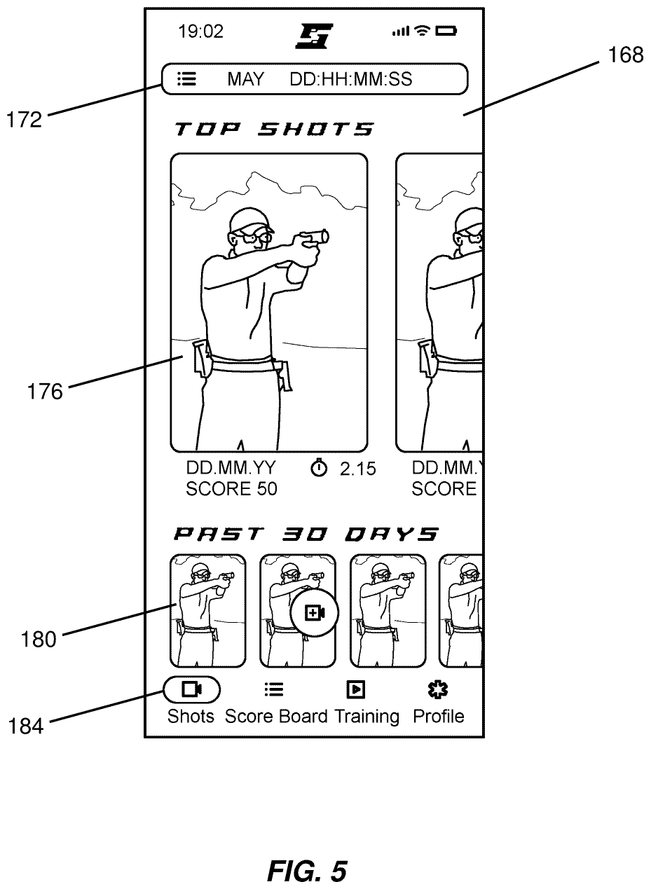

FIG. 5 shows a drawing of top shots screen 168 which may be displayed in association with the score board 56 such as in displaying scores 100. The top shots screen 168 includes a display window 172 that shows the time remaining in a current competition period or shot period or a start or stop date associated with a competition period. Display windows 176 show a thumbnail preview of recent shots or top scoring shots that the user has taken and allows the user to select these shots to view the recorded shot. A user interface element such as a button or slider may be provided to switch between top shots or recent shots. Alternately, the screen 168 may include display windows 176 for top shots and a separate series of display windows 180 for recent shots. A user interface navigation bar 184 may include navigation buttons that allow the user to navigate between different screens or sections within the firearm draw motion tracking and scoring system, such as navigating between display screens to view shots, the user's score board, training videos, profile settings, and the display screen for taking a new shot.

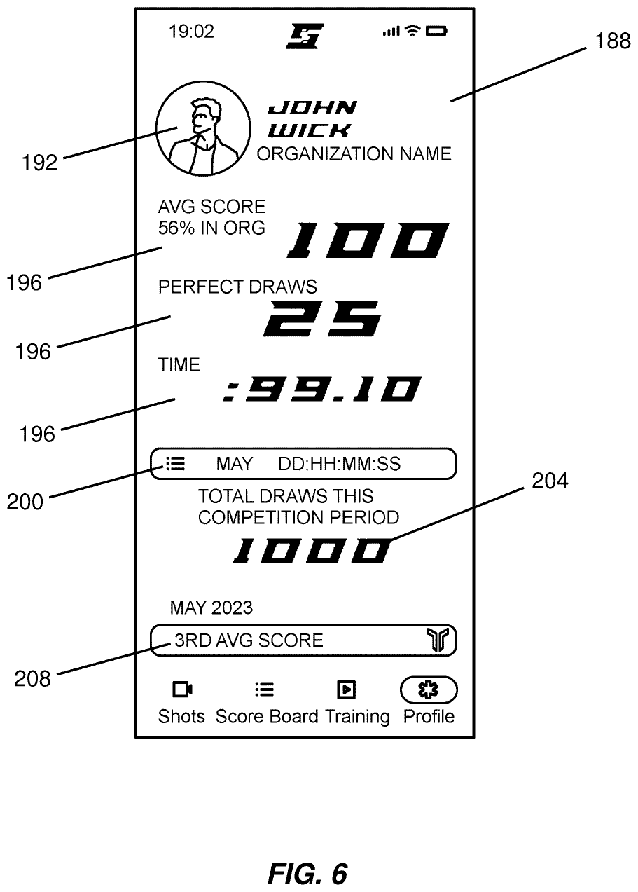

FIG. 6 shows a drawing of a user statistics or score screen 188. The statistics screen 188 includes a data tile or window 192 that identifies the user and one or more data tiles or windows 196 that provide information about the user's shooting performance. Each data tile 196 may display a piece of information such as average shot scores, number of perfect shots, and average shot time. The screen may also display a display tile or window 200 that shows the time remaining in a current competition period or shot period and a display tile or window 204 that displays the number of shots taken during the competition period. A display tile or window 208 may display the user's current rank in an associated competition.

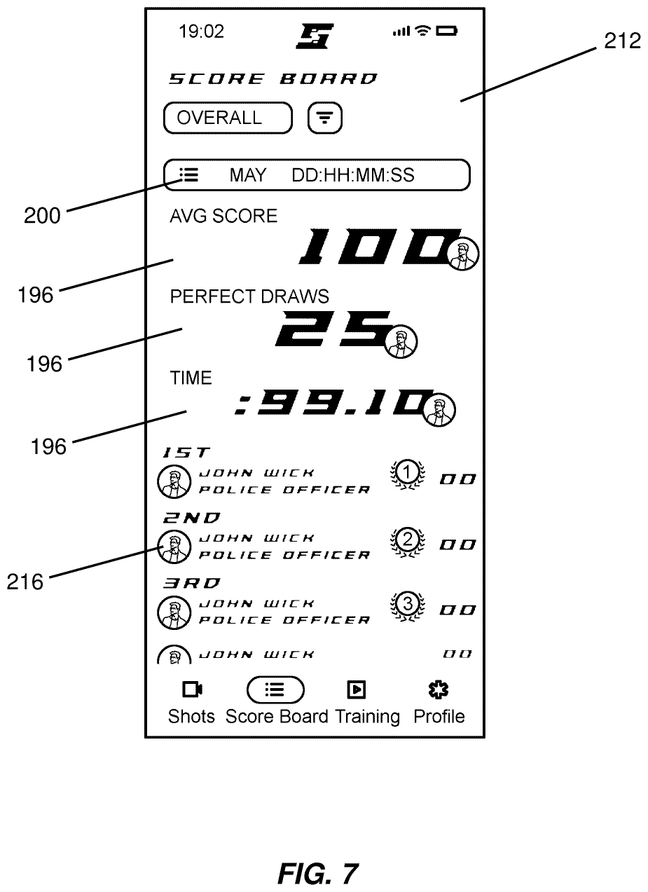

FIG. 7 shows a drawing of a scoreboard screen 212. The scoreboard screen 212 displays data tiles 196 that display a piece of information such as average shot scores, number of perfect shots, and average shot time pertaining to the user or to a current competition period. The screen may also display a display window 200 that shows the time remaining in a current competition period or shot period. The scoreboard screen 212 displays a data tile or window 216 that displays the user's current rank within an associated competition or organization.

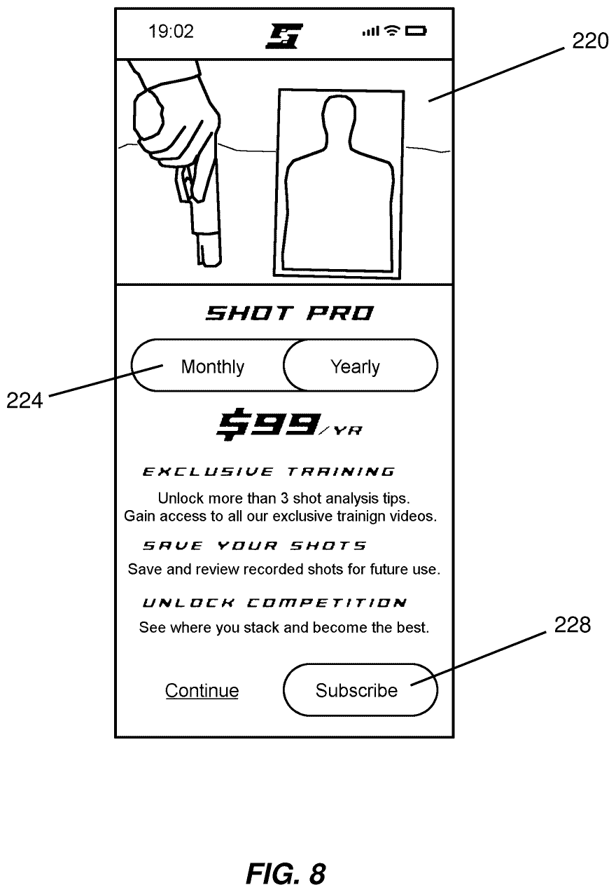

FIG. 8 shows a drawing of a subscription screen 220 as may be displayed in association with selecting a subscription 40 or entering user profile information 64. The subscription screen may include user interface buttons 224, 228 that allow a user to select a premium subscription to unlock additional features within the firearm draw motion tracking and scoring system as well as a description of features that are available to the user under different subscription levels.

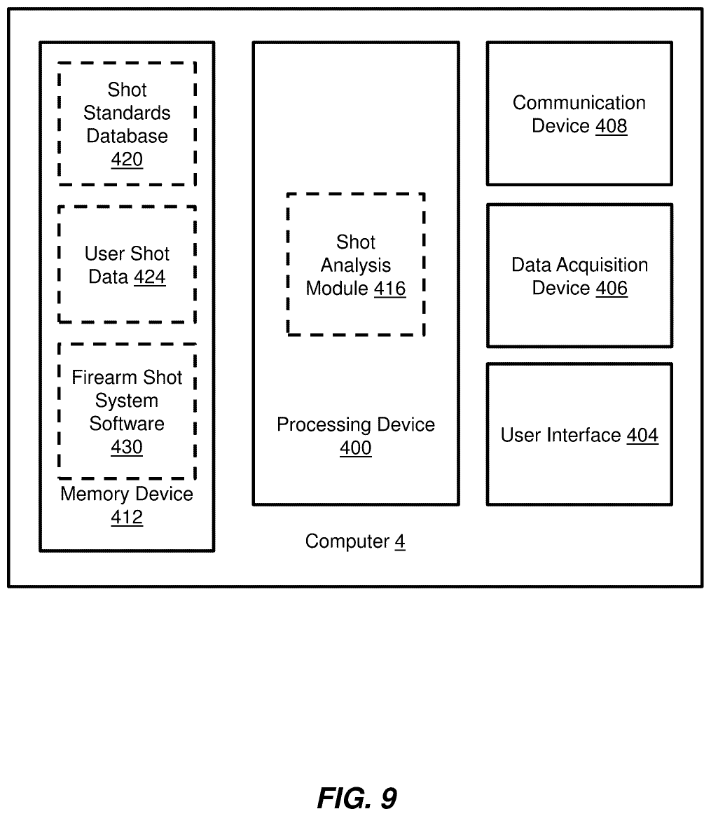

Referring now to FIG. 9, a schematic illustrating example components of the computer 4 is shown. In one example, the computer 4 includes a processing device 400, a user interface 404, a data acquisition device 406, a communication device 408, and a memory device 412. It is noted that the computer 4 can include other components and some of the components are not required in every example.

The processing device 400 can include memory, e.g., read only memory (ROM) and random access memory (RAM), storing processor-executable instructions and one or more processors that execute the processor-executable instructions. In embodiments where the processing device 400 includes two or more processors, the processors can operate in a parallel or distributed manner. The processing device 400 can execute the operating system of the computer 4. In the illustrative example, the processing device 400 may also execute a software module 416 such as a firearm shot analysis module 416.

The firearm shot analysis module 416 allows the computer 4 to communicate with a user and to complete various processing and storage tasks associated with the firearm draw motion tracking and scoring system described herein. The firearm shot analysis module 416 allows the computer 4 to receive account and subscription information from a server computer 16. The firearm shot analysis module 416 allows the computer 4 to receive an audible signal from a user to start a firearm shot. The firearm shot analysis module 416 allows the computer 4 to provide an audible signal to the user after a random period of time to indicate to the user that the user should begin the shot. The firearm shot analysis module 416 allows the computer 4 to receive video image data from a video camera that shows the user drawing, presenting, and discharging the firearm (a shot). The firearm shot analysis module 416 allows the computer 4 to generate a user skeletal wireframe model in real time that is based on the image of the user and that includes nodes that correspond to predetermined anatomical landmarks on the user. The firearm shot analysis module 416 allows the computer 4 to present a video image of the user that is overlaid with the user skeletal wireframe model in real time. The firearm shot analysis module 416 allows the computer to record a video of the user drawing, presenting, and discharging the firearm with the user skeletal model overlaid over the user in the recorded video. The firearm shot analysis module 416 allows the computer 4 to analyze the user's motion in drawing, presenting, and discharging the firearm by comparing the user motion with ideal motion and to generate a motion score corresponding to the accuracy of user motion. The firearm shot analysis module 416 allows the computer 4 to analyze elapsed time for the user to draw, present, and discharge the firearm and to generate a time score for the elapsed time with the time score decreasing for elapsed times longer than a predetermined value. The firearm shot analysis module 416 allows the computer 4 to generate a shot score from the movement score and the time score and present the shot score to the user with the video of the user's shot with an overlaid user skeletal wireframe model. The firearm shot analysis module 416 allows a computer 4 to provide feedback to the user for user improvement based on particular user deficiency in drawing, presenting and discharging the firearm.

The user interface 404 is a device that allows a user such as the client or user to interact with the computer 4. While one user interface 404 is shown, the term “user interface” can include, but is not limited to, a local computer or a remote computer and parts thereof such as a touch screen, a physical keyboard, a mouse, a microphone, and/or a speaker. An example computer 4 is a mobile phone or tablet computer that includes a touch screen, camera, and microphone. The computer user interface 404 allows for management of the firearm draw motion tracking and scoring system. The user interface 404 receives input from a user and allows the computer and system to take action based on that input.

The data acquisition device 406 is one or more devices that allow the computer 4 to receive sound and image data associated with the user drawing, presenting, and discharging a firearm. The data acquisition device may include a camera and a microphone.

The communication device 408 is a device that allows the computer 4 to communicate with another device; such as a server 16. The communication device 408 can include one or more wireless transceivers for performing wireless communication and/or one or more communication ports for performing wired communication. The communication device may transmit and receive account and subscription information with the server 16 and may allow for communications to facilitate user participation in organizations, groups, and competitions as well as in scoring the user relative to other users.

The memory device 412 is a device that stores customized software programming to thereby implement the firearm draw motion tracking and scoring system described herein. The memory device 412 also stores data generated or received by the computer 4 by the firearm draw motion tracking and scoring system and may provide data to the processing device 400. The memory device 412 can include, but is not limited to, a hard disc drive, an optical disc drive, and/or a flash memory drive. The memory device 412 may include a shot standards database 420 which stores data regarding timing and motion associated with an ideal shot and which may store information for different types of shots or firearms. The memory device 412 may also include user shot data 424 including recorded shots and shot scores, and other recorded data which may be used by the computer 4 to score the user's shots and to rank the user relative to other users. The memory device 412 may also store firearm draw motion tracking and scoring system software 430. The memory device may also have other tables, databases, or modules as are necessary to implement the various tasks and examples discussed herein.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A computer implemented method for firearm draw motion tracking and scoring comprising:
a computer having a processor and memory receiving, from an electronic video camera, a video of a user drawing and presenting a firearm to discharge the firearm;
the computer analyzing the video and creating, from the video, a user skeletal wireframe model specific to the user, the user skeletal wireframe model comprising skeletal anchor point nodes representing predetermined anatomical landmark skeletal joints, the skeletal anchor point nodes comprising nodes representing the user's hips, shoulders, elbows, wrists, and fingers, and wherein the skeletal wireframe model comprises lines connecting the nodes wherein the lines represent user skeletal bones, wherein the user skeletal wireframe model is an animated model that represents position and movement of the user as the user draws and presents the firearm to discharge the firearm;
the computer overlaying the user skeletal wireframe model on the video of the user wherein nodes are positioned over the video of the user in locations that correspond to associated user anatomical features;
the computer analyzing the movement of the user skeletal wireframe model and comparing the movement of the user skeletal wireframe model with an ideal movement for drawing and presenting the firearm to discharge the firearm to thereby score the user motion in drawing, presenting, and discharging the firearm;
the computer generating a shot score for the user in drawing and presenting the firearm to discharge the firearm; and
the computer providing the shot score to the user.

2. The method of claim 1, wherein the shot score comprises a movement accuracy score combined with a movement time score.

3. The method of claim 2, wherein the movement accuracy score corresponds to the user's accuracy of motion in drawing and presenting the firearm to discharge the firearm compared with the ideal movement for drawing and presenting the firearm to discharge the firearm.

4. The method of claim 3, wherein the movement score is decreased based on an extent of deviation between user motion and ideal motion in drawing and presenting the firearm to discharge the firearm.

5. The method of claim 2, wherein the time score is based on an elapsed time for the user drawing and presenting the firearm to discharge the firearm, and wherein the time score decreases for an elapsed time that is greater than a predetermined time.

6. The method of claim 1, wherein the method comprises the computer creating the user skeletal wireframe model in real time, and the computer presenting the video with the skeletal wireframe overlay to the user via a computer screen in real time as the user performs the motion of drawing and presenting the firearm to discharge the firearm.

7. The method of claim 1, wherein the method comprises the computer visually analyzing user limbs to identify a central axis of the user limb and creating a wireframe line representing a user limb bone along the identified central axis.

8. The method of claim 7, wherein the method comprises the computer identifying an intersection between a first central axis of a first user limb and a second central axis of a second user limb and placing a node at the intersection.

9. The method of claim 1, wherein the method comprises the computer creating a quadrilateral including hip joints and shoulder joints to represent the user torso in the user skeletal wireframe.

10. The method of claim 1, wherein the method comprises the computer creating, as part of the user skeletal wireframe, an outlined area designating the user eyes, and the computer analyzing a deviation between a firearm point of aim and a direction that the user's eyes are oriented to determine how accurately the user is looking at the intended target and aiming at the target.

11. The method of claim 1, wherein the method comprises the computer detecting, via a microphone associated with the computer, the discharge of the firearm by identifying at least one sound selected from the group consisting of a sound of a live firearm discharge and a sound of a firearm dry fire.

12. The method of claim 1, wherein the method comprises the computer verifying that the user is properly positioned to begin drawing and presenting the firearm to discharge the firearm, the computer waiting for a random amount of time having a predetermined minimum length and a predetermined maximum length, and the computer generating an audible start signal via a speaker associated with the computer to indicate to the user that the user begin drawing and presenting a firearm to discharge the firearm after the random amount of time has passed.

13. The method of claim 1, wherein the method comprises the computer from a user, data regarding a user and data sufficient to create a user account on the computer including a group to which the user belongs, and the computer ranking the user shot score with shot scores from other users that belong to the group.

14. A computer implemented method for firearm draw motion tracking and scoring comprising:
a computer having a processor and memory receiving, from an electronic video camera, a video of a user drawing and presenting a firearm to discharge the firearm;
the computer analyzing the video and identifying, from the video, a user skeletal model specific to the user, the user skeletal wireframe model comprising nodes which represent at least one of user hands, arms, and torso, wherein the user skeletal model identifies the location and movement of the nodes as the user moves to draw and present the firearm for discharge;
the computer analyzing the movement of the user skeletal model and comparing the movement of the user skeletal model with a computer stored ideal movement for drawing and presenting the firearm to discharge the firearm to thereby score the user motion in drawing and presenting a firearm to discharge a firearm based on a deviation between the user movement and the ideal movement; and
the computer generating a shot score for the user in drawing and presenting the firearm to discharge the firearm based on a deviation between the user movement and the ideal movement.

15. The method of claim 14, wherein the method comprises the computer overlaying the user skeletal model on the video of the user wherein user skeletal model nodes are positioned over the video of the user in locations that correspond to associated user anatomical features, and the computer presenting the video to the user via a computer screen.

16. The method of claim 15, wherein the method comprises the computer creating the user skeletal model in real time, and the computer presenting the video with the user skeletal model overlay to the user via a computer screen in real time as the user performs the motion of drawing and presenting the firearm to discharge the firearm.

17. The method of claim 14, wherein the method comprises the computer creating, as part of the user skeletal model, an outlined area designating the user eyes, and the computer analyzing a deviation between a firearm point of aim and a direction that the user's eyes are oriented to determine a deviation between a user firearm point of aim and the direction that the user's eyes are oriented, and the computer generating the shot score based on the deviation between the user firearm point of aim and the direction that the user's eyes are oriented.

18. The method of claim 14, wherein the method comprises the computer detecting user completion of drawing and presenting the firearm to discharge the firearm via the camera by determining that the firearm has been moved to a correct position for discharge.

19. The method of claim 14, wherein the method comprises the computer presenting to the user via a screen a live video image of the user, the computer presenting to the user via the screen an alignment box indicating where the user should be positioned while drawing and presenting the firearm for discharge, the computer determining that the user has moved into a correct position whereby the user is positioned within the alignment box, the computer waiting for a random amount of time having a predetermined minimum length and a predetermined maximum length, and the computer generating an audible start signal via a speaker associated with the computer to indicate to the user that the user begin drawing and presenting a firearm to discharge the firearm.

20. The method of claim 14, wherein the method comprises the computer generating the shot score from on a movement accuracy score that is based on the deviation between the user movement and the ideal movement and that is reduced based on a magnitude of said deviation, and a time score that is based on an elapsed time for the user drawing and presenting the firearm to discharge the firearm wherein the time score is decreased for an elapsed time that is greater than a predetermined time.
